(19) United States
(12) Patent Application Publication
(10) Pub. No.: US 2026/0133301 A1
(43) Pub. Date: May 14, 2026

(54) METHOD AND APPARATUS FOR CALIBRATING STRUCTURAL ERRORS IN A CONICAL SCANNING AIRBORNE BATHYMETRIC LIDAR SYSTEM

(71) Applicant: Guilin University of Technology, Guilin (CN)

(72) Inventors: Guoqing ZHOU, Guilin (CN); Gang LIANG, Guilin (CN); Guofu Qin, Guilin (CN); Hanwen GAO, Guilin (CN)

(21) Appl. No.: 19/275,936

(22) Filed: Jul. 21, 2025

(30) Foreign Application Priority Data
Nov. 10, 2024 (CN) 2024115946749

(51) Int. Cl. G01S 7/497; G01C 13/00; G01S 17/42; G01S 17/89

(52) U.S. Cl. CPC G01S 7/497; G01C 13/008; G01S 17/42; G01S 17/89

(57) ABSTRACT

A method and apparatus for calibrating structural errors in a conical scanning airborne bathymetric LiDAR system are provided. The method includes: establishing a structure error calibration field; establishing a global control coordinate system, and acquiring coordinates of global control points, survey stations, local control points and a reflector center by using a total station; acquiring slope distances from the reflector center to laser footprints on laser retroreflective targets and drive motor rotation angles, and acquiring coordinates of the laser footprints by utilizing the total station; based on displacement and rotation geometrical relationships between a laser scanning reference coordinate system and the global control coordinate system, constructing an error equation based on the slope distances, the drive motor rotation angles, and coordinates of the laser footprints; and iteratively solving the error equation based on a least-squares adjustment of indirect observation principle to obtain structural error values of the LiDAR system.

### CROSS-REFERENCE TO RELATED APPLICATION

This application claims priority to Chinese patent application No. CN 202411594674.9, filed to China National Intellectual Property Administration (CNIPA) on Nov. 10, 2024, which is herein incorporated by reference in its entirety.

### TECHNICAL FIELD

The disclosure relates to the technical field of airborne bathymetric light detection and ranging (LiDAR) systems, and in particular to a method and an apparatus for calibrating structural errors in a conical scanning airborne bathymetric LiDAR system (also referred to as an oval scanning airborne bathymetric LiDAR system).

### BACKGROUND

Airborne bathymetric LiDAR system is an advanced shallow-water measurement technology that realizes high-resolution joint measurement of aquatic and terrestrial areas by emitting blue-green band laser pulses and receiving echo signals. This system integrates airborne bathymetric LiDAR, global navigation satellite system (GNSS) and an inertial navigation system (INS), enabling rapid acquisition of high-precision three-dimensional topographic data for both water and land under complex terrain conditions. It is widely applicable to topographic mapping, environmental monitoring, and hydraulic engineering in shallow-water regions. However, as a complex multi-sensor integrated system, the measurement accuracy of the airborne bathymetric LiDAR system is susceptible to multiple sources of errors, among which structural errors are one of critical factors affecting the overall system accuracy. The structural errors primarily originate from machining and assembly deviations of internal LiDAR components, which may lead to measurement data distortion and further compromise the accuracy of water depth calculation. Therefore, effective correction of the structural errors constitutes a pivotal step in enhancing system precision, which can not only significantly improve the accuracy of three-dimensional laser footprint coordinates, but also further improve the measurement quality and reliability of the entire bathymetric LiDAR system.

In patent literatures in the related art, most studies focus on the calibration of boresight misalignment errors in airborne systems. For example, “Geometric Correction Method and Apparatus for UAV-borne Radar Boresight Misalignment errors” (CN114859326A, 2022), “A Boresight misalignment error Correction Method for Airborne Laser Bathymetric Systems” (CN116299369A, 2023), Airborne LiDAR Measurement Technology: Theory and Methodology (Zhang Xiaohong, 2007, Wuhan University Press), “Calibration of airborne LiDAR cloud point data with no calibration field” (Chen Jie et al., 2015, Remote Sensing for Land & Resources), “Design and Validation of Calibration Target for Calibration of Airborne LiDAR Boresight Angles” (Xiao Kai et al., 2017, Journal of Geomatics Science and Technology), “Research on Self-calibration Method of Domestic Spiral Scanning Laser Radar System” (Yang Shujuan et al., 2018, Journal of Electronics & Information Technology), and “Calibration of Laser Scanning Measurement System for Mini UAV” (Tian Lülin et al., 2024, Journal of Information Engineering University).

In addition, some literatures have explored the impact of structural errors on measurement accuracy, yet they primarily address boresight misalignment error calibration and lack effective solutions for structural error calibration. For example, “Theory and Methods of Error Processing for Airborne LiDAR Data” (Wang Liying, 2013, Surveying and Mapping Press), “Positioning Model and Accuracy Evaluation of Conical Scanning Airborne Laser Bathymetric Systems” (Li Kai et al., 2016, Acta Geodaetica et Cartographica Sinica), “Positioning Model and Simulation of Conical Scanning Airborne Laser Bathymetry System” (Shen Erhua et al., 2016, Chinese Journal of Lasers), “The Calibration Model and Simulation Analysis of Circular Scanning Airborne Laser Bathymetry System” (Shen Erhua et al., 2016, Acta Geodaetica et Cartographica Sinica), “Research of Error Analysis and Positioning Accuracy of Airborne Dual-Frequency LiDAR” (Lü Deliang et al., 2018, Laser & Optoelectronics Progress), and “Effect Analysis of Positioning Model and Boresight Error Analysis of Airborne Lidar Bathymetry System” (Yu Jiayong et al., 2019, Infrared and Laser Engineering).

In current patents related to structural error calibration, some methods merely correct measurement coordinates without explicitly quantifying specific structural error values. For example, “Scanning Platform Coordinate System Error Correction Method for Airborne LiDAR Systems” (CN116990787A, 2023). In addition, although some patents involve the calibration of structural error values, the provided values are either incomplete or inapplicable to conical scanning airborne LiDAR systems, such as “A Calibration Method for Airborne LiDAR Ranging Accuracy Based on Circular Scanning” (CN11123245A, 2020) and “A Testing Method for Maximum Ranging Capability and Viewing Angle Accuracy of Circular Scanning Airborne LiDAR” (CN11123246A, 2020).

In summary, the patents and research in the related art are mostly focused on the calibration of boresight misalignment errors in airborne systems. However, for structural error calibration, particularly in applications involving conical scanning airborne bathymetric LiDAR systems, current calibration schemes have failed to effectively address the quantification of structural error values.

### SUMMARY

Aiming at the shortcomings and defects in the related art, the disclosure provides a method and apparatus for calibrating structural errors of a conical scanning airborne bathymetric LiDAR system, resolving the calibration problem of structural error values in such systems.

To achieve the above-mentioned purpose, according to an aspect of the disclosure, the disclosure provides a method for calibrating structural errors in a conical scanning airborne bathymetric LiDAR system, including:
deploying a plurality of global control points, a plurality of local control points, and a plurality of laser retroreflective targets on a target plane of a calibration field, and arranging two survey stations within the calibration field;
establishing a global control coordinate system, and acquiring coordinates of the plurality of global control points in the global control coordinate system using a total station;
determining, based on the coordinates of the plurality of global control points in the global control coordinate system, coordinates of the two survey stations in the global control coordinate system via resection method and trigonometric leveling method;
acquiring, based on the coordinates of the two survey stations in the global control coordinate system, coordinates of the plurality of local control points and a center of an airborne bathymetric LiDAR reflector in the global control coordinate system using a forward intersection method and a trigonometric leveling method;
acquiring slope distances from the center of the airborne bathymetric LiDAR reflector to laser footprints on the plurality of retroreflective targets and drive motor rotation angles using the conical scanning airborne bathymetric LiDAR system;
acquiring, based on the coordinates of the plurality of local control points in the global control coordinate system, coordinates of the laser footprints in the global control coordinate system using the total station;
constructing an error equation according to the slope distances, the drive motor rotation angles, and the coordinates of the laser footprints in the global control coordinate system, based on displacement and rotational geometric relationships between a laser scanning reference coordinate system and the global control coordinate system; and
iteratively solving the error equation using a least-squares adjustment of indirect observation principle to derive structural error values of the conical scanning airborne bathymetric LiDAR system.

In an embodiment, the deploying a plurality of global control points, a plurality of local control points, and a plurality of laser retroreflective targets on a target plane of a calibration field, and arranging two survey stations within the calibration field includes:
orienting the target plane of the calibration field vertically; selecting a point, labeled as G₀, on the target plane to deploy the plurality of global control points, and uniformly distributing the plurality of global control points greater than 1 around the point G₀ in all directions;
uniformly distributing the plurality of laser retroreflective targets greater than 7 each in a rectangular shape around the plurality of global control points in all directions; deploying one local control point at each of a bottom-left corner and a bottom-right corner of each laser retroreflective target; and arranging the two survey stations on a level ground in a front of the target plane of the calibration field, with one survey station of the two survey stations positioned on a left side and another of the two survey stations on a right side.

In an embodiment, the establishing a global control coordinate system, and acquiring coordinates of the plurality of global control points in the global control coordinate system using a total station includes:
establishing the global control coordinate system with the point G₀ as a coordinate origin, a horizontal direction as an X-axis, a vertical direction as a Y-axis, and a Z-axis forming a right-handed system with the X-axis and the Y-axis;
labeling a first global control point of the plurality of global control points as G₁; setting up the total station at an unobstructed location, leveling the total station, and making a center of the total station as O; aligning the total station with the point G₀ for observation, recording a horizontal distance S₁ and a height difference H₁ between the center O and the point G₀, that is, OG₀; zeroing a horizontal circle of the total station, then aligning the total station with the first global control point G₁ for observation, recording a horizontal distance S₂ and a height difference H₂ between the center O and the first global control point G₁, that is, OG₁, and a horizontal angle α among the point G₀, the center O, and the first global control point G₁, that is, G₀OG₁; calculating the coordinates of the first global control point G₁ in the global control coordinate system using:

$$\{ \begin{matrix}x = \pm \sqrt{{S}_{1}^{2} + {S}_{2}^{2} - 2 \times {S}_{1} \times {S}_{2} \times cos ( α )} \\ y = \pm \vert {H}_{2} - {H}_{1} \vert \\ z = 0\end{matrix} ; \qquad ( 1 )$$

where ±depends on a position of a point Gᵢ in the global control coordinate system; when the point Gᵢ is located in a first quadrant of the global control coordinate system, both x and y take positive values; when the point Gᵢ is located in a second quadrant of the global control coordinate system, x takes a negative value and y take a positive value; and
repeating the above steps by aligning the total station with other global control points of the plurality of global control points, recording horizontal distances, height differences, and horizontal angles of the other global control points of the plurality of global control points to substitute into the formula (1) to thereby calculate the coordinates of each global control point in the global control coordinate system.

In an embodiment, the acquiring, based on the coordinates of the plurality of local control points in the global control coordinate system, coordinates of the laser footprints in the global control coordinate system using the total station includes:
assuming one laser footprint of the laser footprints falls on an i-th laser retroreflective target of plurality of laser retroreflective targets, labeling the one laser footprint of the laser footprints as Pᵢ, labeling local control points of the plurality of local control points at a bottom-left corner and a bottom-right corner of each laser retroreflective target as Gᵢ₁ and Gᵢ₂, respectively; establishing a Cartesian coordinate system with the local control point Gᵢ₁ as an origin, Gᵢ₁Gᵢ₂ as an X-axis direction, and a direction perpendicular to the X-axis upward as a Y-axis direction;
setting up the total station at an unobstructed location, leveling the total station, and making a center of the total station as O; aligning the total station with the local control point Gᵢ₁ for observation; recording a horizontal distance S₁ and a height difference H₁ between the center O and the local control point Gᵢ₁, that is, OGᵢ₁; zeroing a horizontal circle of the total station, then aligning the total station with the laser footprint as Pi for observation; recording a horizontal distance S₂ and a height difference H₂ between the center O and the laser footprint Pᵢ, that is, OPᵢ, and a horizontal angle α₁ among the local control point Gᵢ₁, the center O, and the laser footprint Pᵢ, that is, Gᵢ₁OPᵢ; aligning the total station with the local control point Gᵢ₂ for observation; recording a horizontal distance S₃ and a height difference H₃ between the center O and the local control point Gᵢ₂, that is, OGᵢ₂, and a horizontal angle α₂ among the local control point Gᵢ₁, the center O, and the local control point Gᵢ₂, that is, Gᵢ₁OGᵢ₂;
calculating a distance Gᵢ₁Gᵢ₂ between the local control point Gᵢ₁ and the local control point Gᵢ₂:

$${S}_{{G}_{i 1} {G}_{i 2}} = \sqrt{{( {x}_{{G}_{i 1}} - {x}_{{G}_{i 2}} )}^{2} + {( {y}_{{G}_{i 1}} - {y}_{{G}_{i 2}} )}^{2}} ;$$

where (x_{G}_{ᵢ₁}, y_{G}_{ᵢ₁}) and (x_{G}_{ᵢ₂}, y_{G}_{ᵢ₂}) are x, y coordinates of the local control point Gᵢ₁ and the local control point Gᵢ₂ in the global control coordinate system;
calculating a distance Gᵢ₁Pᵢ between the local control point Gᵢ₁ and the laser footprint Pᵢ:

$${S}_{{G}_{i 1} {P}_{i}} = \sqrt{{( {H}_{2} - {H}_{1} )}^{2} + {S}_{1}^{2} + {S}_{2}^{2} - 2 \times {S}_{1} \times {S}_{2} \times cos ( {α}_{1} )} ;$$

calculating a distance PᵢGᵢ₂ between the laser footprint Pᵢ and the local control point Gᵢ₂:

$${S}_{{P}_{i} {G}_{i 2}} = \sqrt{{( {H}_{2} - {H}_{3} )}^{2} + {S}_{2}^{2} + {S}_{3}^{2} - 2 \times {S}_{2} \times {S}_{3} \times cos ( {α}_{2} - {α}_{1} )} ;$$

calculating an angle ∠PᵢGᵢ₁Gᵢ₂ based on S_{G}_{ᵢ₁}_{G}_{ᵢ₂}, S_{G}_{ᵢ₁}_{P}_{ᵢ}, and S_{P}_{ᵢ}G₂:

$$∠ {P}_{i} {G}_{i 1} {G}_{i 2} = {cos}^{- 1} ( ( {S}_{{G}_{i 1} {P}_{i}}^{2} + {S}_{{G}_{i 1} {G}_{i 2}}^{2} - {S}_{{P}_{i} {G}_{i 2}}^{2} ) ) / ( 2 \times {S}_{{G}_{i 1} {P}_{i}} \times {S}_{{G}_{i 1} {G}_{i 2}} ) ) ;$$

calculating coordinates of the laser footprints in the Cartesian coordinate system based on the angle ∠PᵢGᵢ₁Gᵢ₂:

$$\{ \begin{matrix}{x}^{′} = {S}_{{G}_{i 1} {P}_{i}} \times cos ( ∠ {P}_{i} {G}_{i 1} {G}_{i 2} ) \\ {y}^{′} = {S}_{{G}_{i 1} {P}_{i}} \times sin ( ∠ {P}_{i} {G}_{i 1} {G}_{i 2} )\end{matrix} ;$$

converting the coordinates of the laser footprints in the Cartesian coordinate system to the global control coordinate system:

$$\{ \begin{matrix}x = {x}_{{G}_{i 1}} + {x}^{′} \times cos ( β ) - {y}^{′} \times sin ( β ) \\ y = {y}_{{G}_{i 1}} + {x}^{′} \times sin ( β ) + {y}^{′} \times cos ( β ) \\ z = 0\end{matrix} ;$$

$$where β = {tan}^{- 1} ( ( {y}_{{G}_{i 2}} - {y}_{{G}_{i 1}} ) / ( {x}_{{G}_{i 2}} - {x}_{{G}_{i 1}} ) ) .$$

In an embodiment, the constructing an error equation according to the slope distances, the drive motor rotation angles, and the coordinates of the laser footprints in the global control coordinate system, based on displacement and rotational geometric relationships between a laser scanning reference coordinate system and the global control coordinate system includes:
establishing a laser scanning reference coordinate system with the center of the airborne bathymetric LiDAR reflector as an origin, a carrier flight direction as a Y-axis, a Z-axis vertically upward, and an X-axis forming a right-handed system with the Y-axis and the Z-axis;
rotating the conical scanning airborne bathymetric LiDAR system to align the X-axis, the Y-axis, and the Z-axis of the laser scanning reference coordinate system with the X-axis, the Y-axis, and the Z-axis of the global control coordinate system; wherein, theoretically, an incident laser beam and a drive motor rotation shaft lie in a same plane, an XZ-plane, with the incident laser beam horizontally incident along a negative direction of the X-axis toward the center of the airborne bathymetric LiDAR reflector;
defining a slope distance of the laser footprints as S, the drive motor rotation angles as θ, and calculating coordinates of the laser footprints in the laser reference coordinate system using:

$$[ \begin{matrix}{X}_{L} \\ {Y}_{L} \\ {Z}_{L}\end{matrix} ] = [ \begin{matrix}{f}_{x} ( S , θ , μ , Δ ω , Δ η , Δ S , Δ θ \\ {f}_{y} ( S , θ , μ , Δ ω , Δ η , Δ S , Δ θ \\ {f}_{z} ( S , θ , μ , Δ ω , Δ η , Δ S , Δ θ\end{matrix} ] ;$$

where fₓ, f_{y} and f_{z} are formulas of an error-integrated positioning model for x, y, and z coordinates of the conical scanning airborne bathymetric LiDAR system, and (μ, Δω, Δη, ΔS, Δθ) are parameters of the structural errors, with μ representing an angle between the incident laser beam and the X-axis of the laser reference coordinate system, Δω representing an angular error between the incident laser beam and the drive motor rotation shaft, Δη representing an angular error between a reflector normal and the drive motor rotation shaft, ΔS representing a laser ranging error, and Δθ representing a drive motor rotation angle error;
defining the coordinates of the center of the airborne bathymetric LiDAR reflector in the global control coordinate system as (ΔX, ΔY, ΔZ), and calculating the coordinates of the laser footprints in the global control coordinate system using:

$$[ \begin{matrix}{X}_{G} \\ {Y}_{G} \\ {Z}_{G}\end{matrix} ] = R ( α , β , γ ) [ \begin{matrix}{X}_{L} \\ {Y}_{L} \\ {Z}_{L}\end{matrix} ] + [ \begin{matrix}Δ X \\ Δ Y \\ Δ Z\end{matrix} ] = F ( S , θ , μ , Δ ω , Δ η , Δ S , Δ θ , α , β , γ ) ;$$

where F is a calibration model with eight undetermined parameters (μ, Δω, Δη, ΔS, Δθ, α, β, γ), and R(α, β, γ) is a rotation matrix from the laser scanning reference coordinate system to the global control coordinate system, defined as:

$$R ( α , β , γ ) = [ \begin{matrix}cos α cos γ + sin α sin β sin γ & sin γ cos β & sin α cos γ - cos α sin β sin γ \\ \text{} - cos α sin γ + sin α sin β cos γ & cos γ cos β & - sin α sin γ - cos α sin β cos γ \\ - sin γ cos β & sin β & cos α cos β\end{matrix} ] ;$$

where (α, β, γ) are rotation angles around the X-axis, the Y-axis, and the Z-axis of the global control coordinate system respectively;
linearizing the calibration model to derive the error equation:

$$[ \begin{matrix}{V}_{x} \\ {V}_{y} \\ {V}_{z}\end{matrix} ] = ( \frac{\partial F}{\partial μ} ) δμ + ( \frac{\partial F}{\partial Δ ω} ) δΔ ω + ( \frac{\partial F}{\partial Δ η} ) δΔ η + ( \frac{\partial F}{\partial Δ S} ) δΔ S + ( \frac{\partial F}{\partial Δ θ} ) δΔ θ + ( \frac{\partial F}{\partial α} ) δα + ( \frac{\partial F}{\partial β} ) δβ + ( \frac{\partial F}{\partial γ} ) δγ - [ \begin{matrix}{X}_{G} - ( {X}_{G} ) \\ {Y}_{G} - ( {Y}_{G} ) \\ {Z}_{G} - ( {Z}_{G} )\end{matrix} ] ;$$

where (X_{G}, Y_{G}, Z_{G}) are the coordinates of the laser footprints in the global control coordinate system measured using the total station, and ((X_{G}), (Y_{G}), (Z_{G})) are the coordinates of the laser footprints in the global control coordinate system calculated by substituting the slope distance, the drive motor rotation angles, and approximate values of the undetermined parameters into the calibration model.

In an embodiment, the error-integrated positioning model of the conical scanning airborne bathymetric LiDAR system includes:
considering a horizontal oblique incidence of the incident laser beam onto the center of the airborne bathymetric LiDAR reflector, a direction vector of the incident laser beam in the laser scanning reference coordinate system is:

$${A}_{in} = [ \begin{matrix}- cos μ \\ - sin μ \\ 0\end{matrix} ] ;$$

defining an angle between the incident laser beam and the drive motor rotation shaft as ω, accounting for the angular error Δω, rotating the laser scanning reference coordinate system counterclockwise along the Y-axis of the laser scanning reference coordinate system by ω+Δω to align the Z-axis of the laser scanning reference coordinate system with the drive motor rotation shaft, thereby establishing a laser scanning auxiliary coordinate system, wherein a direction vector of the incident laser beam in the laser scanning auxiliary coordinate system is:

$${A}_{in}^{′} = [ \begin{matrix}cos ( ω + Δ ω ) & 0 & sin ( ω + Δ ω ) \\ 0 & 1 & 0 \\ - sin ( ω + Δ ω ) & 0 & cos ( ω + Δ ω )\end{matrix} ] \cdot {A}_{in} ;$$

defining an angle between the reflector normal and the drive motor rotation shaft as η, accounting for the angular error Δη and the drive motor rotation angle error Δθ, wherein a direction vector of the reflector normal in the laser scanning auxiliary coordinate system is:

$$N = [ \begin{matrix}{N}_{x} \\ {N}_{y} \\ {N}_{z}\end{matrix} ] = [ \begin{matrix}sin ( η + Δ η ) cos ( θ + Δ θ ) \\ sin ( η + Δ η ) sin ( θ + Δ θ ) \\ - cos ( η + Δ η )\end{matrix} ] ;$$

reversing the direction vector A′ᵢₙ and then rotating by 180° around N to obtain a direction vector of a reflected beam in the laser scanning auxiliary coordinate system as follows:

$${A}_{out}^{′} = [ \begin{matrix}2 {N}_{x}^{2} - 1 & 2 {N}_{x} {N}_{y} & 2 {N}_{x} {N}_{z} \\ 2 {N}_{x} {N}_{y} & 2 {N}_{y}^{2} - 1 & 2 {N}_{y} {N}_{z} \\ 2 {N}_{x} {N}_{z} & 2 {N}_{y} {N}_{z} & 2 {N}_{z}^{2} - 1\end{matrix} ] \cdot - {A}_{in}^{′} ;$$

rotating the direction vector A′ₒᵤₜ clockwise around a Y-axis of the laser scanning auxiliary coordinate system by ω+Δω to obtain a direction vector of the reflected beam in the laser scanning reference coordinate system as follows:

$${A}_{out} = [ \begin{matrix}cos ( ω + Δ ω ) & 0 & - sin ( ω + Δ ω ) \\ 0 & 1 & 0 \\ sin ( ω + Δ ω ) & 0 & cos ( ω + Δ ω )\end{matrix} ] \cdot {A}_{out}^{′} ;$$

defining a propagation speed of light in air as c, measuring a propagation time of a laser from the center of the airborne bathymetric LiDAR reflector to the laser footprint points through waveform detection as Δt, accounting for the laser ranging error ΔS, wherein a slope distance of laser propagation in air is calculated as:

$${S}^{′} = S + Δ S = 1 / 2 \times c \times Δ t + Δ S ;$$

thus, the coordinates of the laser footprints in the laser scanning reference coordinate system are:

$$[ \begin{matrix}{X}_{L} \\ {Y}_{L} \\ {Z}_{L}\end{matrix} ] = [ \begin{matrix}{f}_{x} ( S , θ , μ , Δ ω , Δ η , Δ S , Δ θ ) \\ {f}_{y} ( S , θ , μ , Δ ω , Δ η , Δ S , Δ θ ) \\ {f}_{z} ( S , θ , μ , Δ ω , Δ η , Δ S , Δ θ )\end{matrix} ] = {S}^{′} \cdot {A}_{out} .$$

In an embodiment, the iteratively solving the error equation using a least-squares adjustment of indirect observation principle to derive structural error values of the conical scanning airborne bathymetric LiDAR system includes:
expressing the error equations in a matrix form: V=BX−L;
   where X=[δμ, δΔω, δΔη, δΔS, δΔθ, δα, δβ, δγ]^{T};
assuming a total number of the laser footprints as n laser footprints:

$$V = [ \begin{matrix}{V}_{1} \\ {V}_{2} \\ ⋮ \\ {V}_{i} \\ ⋮ \\ {V}_{n}\end{matrix} ] , B = [ \begin{matrix}{B}_{1} & 0 & … & 0 \\ 0 & {B}_{2} & … & 0 \\ ⋮ & ⋮ & {B}_{i} & ⋮ \\ 0 & 0 & … & {B}_{n}\end{matrix} ] , L = [ \begin{matrix}{L}_{1} \\ {L}_{2} \\ ⋮ \\ {L}_{i} \\ ⋮ \\ {L}_{n}\end{matrix} ] ;$$

where i represents an i-th laser footprint, and for each laser footprint:

$${V}_{i} = [ \begin{matrix}{V}_{ix} \\ {V}_{iy} \\ {V}_{iz}\end{matrix} ] ;$$

$${B}_{i} = [ \begin{matrix}\frac{\partial {F}_{x}}{\partial μ} & \frac{\partial {F}_{x}}{\partial Δ ω} & \frac{\partial {F}_{x}}{\partial Δ η} & \frac{\partial {F}_{x}}{\partial Δ S} & \frac{\partial {F}_{x}}{\partial Δ θ} & \frac{\partial {F}_{x}}{\partial α} & \frac{\partial {F}_{x}}{\partial β} & \frac{\partial {F}_{x}}{\partial γ} \\ \frac{\partial {F}_{y}}{\partial μ} & \frac{\partial {F}_{y}}{\partial Δ ω} & \frac{\partial {F}_{y}}{\partial Δ η} & \frac{\partial {F}_{y}}{\partial Δ S} & \frac{\partial {F}_{y}}{\partial Δ θ} & \frac{\partial {F}_{y}}{\partial α} & \frac{\partial {F}_{y}}{\partial β} & \frac{\partial {F}_{y}}{\partial γ} \\ \frac{\partial {F}_{z}}{\partial μ} & \frac{\partial {F}_{z}}{\partial Δ ω} & \frac{\partial {F}_{z}}{\partial Δ η} & \frac{\partial {F}_{z}}{\partial Δ S} & \frac{\partial {F}_{z}}{\partial Δ θ} & \frac{\partial {F}_{z}}{\partial α} & \frac{\partial {F}_{z}}{\partial β} & \frac{\partial {F}_{z}}{\partial γ}\end{matrix} ] ;$$

$${L}_{i} = [ \begin{matrix}{X}_{iG} - ( {X}_{iG} ) \\ {Y}_{iG} - ( {Y}_{iG} ) \\ {Z}_{iG} - ( {Z}_{iG} )\end{matrix} ] ;$$

formulating a normal equation based on the least-squares adjustment of indirect observation principle as:

$${B}^{T} BX = {B}^{T} L ;$$

solving the above normal equation as:

$$X = {( {B}^{T} B )}^{- 1} {B}^{T} L ;$$

substituting the coordinates of the laser footprints in the global control coordinate system (X_{G}, Y_{G}, Z_{G}), the slope distance S, the drive motor rotation angles θ, and approximate values of the undetermined parameters (μ, Δω, Δη, ΔS, Δθ, α, β, γ) into the above formulas to derive correction parameters of the undetermined parameters as ( [symbol] );
updating the undetermined parameters based on the correction parameters ( [symbol] , [symbol] ) as:

$$μ + \dot{μ} \to μ ;$$

$$Δ ω + \dot{Δ ω} \to Δ ω ;$$

$$Δ η + \dot{Δ η} \to Δ η ;$$

$$Δ S + \dot{Δ S} \to Δ S ;$$

$$Δ θ + \dot{Δ θ} \to Δ θ ;$$

$$α + \dot{α} \to α ;$$

$$β + \dot{β} \to β ;$$

$$γ + \dot{γ} \to γ ;$$

and
recalculating the coordinates of the laser footprints ((X_{G}), (Y_{G}), (Z_{G})) in the global control coordinate system using the undetermined parameters (μ, Δω, Δη, ΔS, Δθ, α, β, γ) after the updating, then recalculating a matrix B and a matrix L, and solving the normal equation of the error equation via the least-squares adjustment of indirect observation principle to obtain new correction parameters ( [symbol] ); repeating the above steps iteratively until absolute values of all correction parameters are less than 0.001.

According to another aspect of the disclosure, an apparatus for calibrating structural errors in a conical scanning airborne bathymetric LiDAR system, including: a first layout module, a second layout module, a first acquisition module, a second acquisition module, a third acquisition module, a fourth acquisition module, a fifth acquisition module, a construction module, and a computation module.

The first layout module is configured (i.e., structured and arranged) to deploy a plurality of global control points, a plurality of local control points, and a plurality of laser retroreflective targets on a target plane of a calibration field, and arrange two survey stations within the calibration field.

The second layout module is configured to deploy the conical scanning airborne bathymetric LiDAR system and a total station within a calibration field.

The first acquisition module is configured to acquire coordinates of the plurality of global control points in a global control coordinate system.

The second acquisition module is configured to acquire coordinates of the survey stations in the global control coordinate system.

The third acquisition module is configured to acquire coordinates of the plurality of local control points and a center of an airborne bathymetric LiDAR reflector in the global control coordinate system.

The fourth acquisition module is configured to acquire slope distances from the center of the airborne bathymetric LiDAR reflector to laser footprints on the plurality of retroreflective targets and drive motor rotation angles.

The fifth acquisition module is configured to acquire coordinates of the laser footprints in the global control coordinate system.

The construction module is configured to construct an error equation.

The computation module is configured to solve the error equation to derive structural error values of the conical scanning airborne bathymetric LiDAR system.

Compared to the related art, the disclosure has the following beneficial effects. Firstly, the disclosure proposes a calibration field construction scheme suitable for structural error calibration, which includes multiple global control points, local control points, laser retroreflective target, and two survey stations. Secondly, the disclosure proposes an airborne bathymetric LiDAR positioning model of conical scanning type that takes into account errors. This model comprehensively considers five key structural errors: incident light skew angle error, the angular error between the incident laser beam and the drive motor rotation shaft, the angular error between a reflector normal and the drive motor rotation shaft, the laser ranging error, and the drive motor rotation angle error. Based on this, it derives a precise calibration model and then constructs an error equation. Finally, it uses indirect least squares adjustment to iteratively solve the error equation, thereby accurately obtaining the structural error values. By effectively correcting these structural errors, it can significantly improve the accuracy of the three-dimensional coordinates of the laser footprints, thus enhancing the measurement quality and reliability of the entire bathymetric system.

### BRIEF DESCRIPTION OF DRAWINGS

FIG. 1 illustrates a schematic flowchart of a method for calibrating structural errors in a conical scanning airborne bathymetric LiDAR system according to the disclosure.

FIG. 2 illustrates a schematic diagram of a calibration field.

FIG. 3 illustrates a schematic diagram of a global control coordinate system.

FIG. 4 illustrates a schematic distribution diagram of local control point coordinates.

FIG. 5 illustrates a schematic diagram of a Cartesian coordinate system

FIG. 6 illustrates a schematic process diagram of iterative solving of an error equation.

FIG. 7 illustrates a schematic distribution diagram of laser footprint coordinates before and after structural error calibration.

FIG. 8 illustrates a schematic error diagram of coordinates before and after the structural error calibration.

FIG. 9 illustrates a schematic diagram of an apparatus for calibrating structural errors in a conical scanning airborne bathymetric LiDAR system according to the disclosure.

### DETAILED DESCRIPTION OF EMBODIMENTS

In order to make purposes, technical solutions and advantages of embodiments of the disclosure clearer, the technical solutions in the embodiments of the disclosure will be described clearly and completely in combination with the drawings attached to the embodiments of the disclosure. Apparently, the illustrated embodiments are a part of the embodiments of the disclosure, but not all of the whole embodiments. Based on the embodiments of the disclosure, all other embodiments obtained by those skilled in the art without creative work are within the scope of the disclosure.

The measurement errors of airborne bathymetric LiDAR systems are mainly divided into system integration errors and single-machine errors. The system integration errors mainly include boresight misalignment errors of an airborne bathymetric LiDAR and INS, and eccentricity errors of the airborne bathymetric LiDAR and GNSS. The single-machine errors mainly refer to errors of the airborne bathymetric LiDAR, INS, and GNSS themselves. Among them, structural errors caused by the processing and assembly deviations of internal components of the airborne bathymetric LiDAR are the main source of the single-machine errors. The system integration errors can be corrected through flight calibration, while the structural errors cannot be eliminated through flight dynamic calibration and must be ground statically calibrated before flight. Calibration of the structural errors can not only evaluate the quality of the equipment, but also correct system errors in subsequent data processing, significantly improving the accuracy of the three-dimensional coordinates of laser footprints, thereby improving the measurement quality and reliability of the entire bathymetric system.

### Embodiment 1

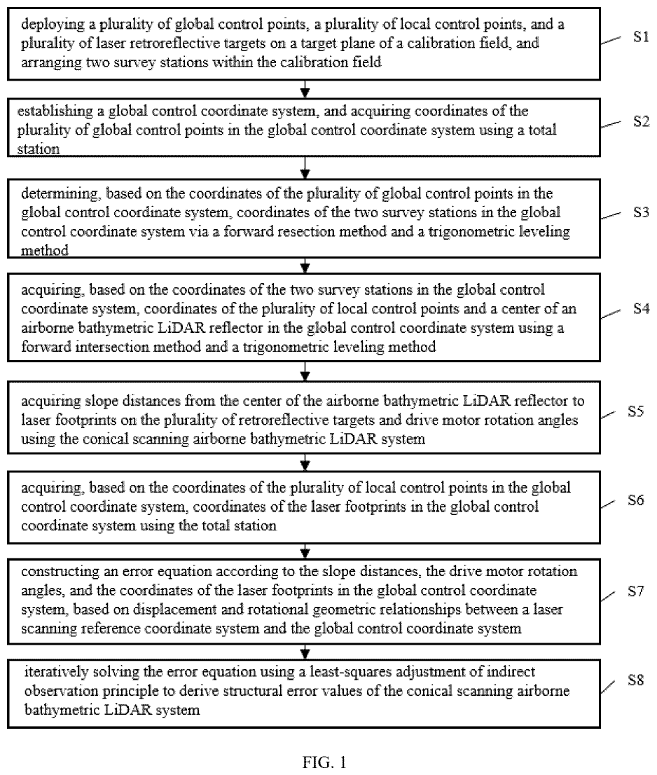

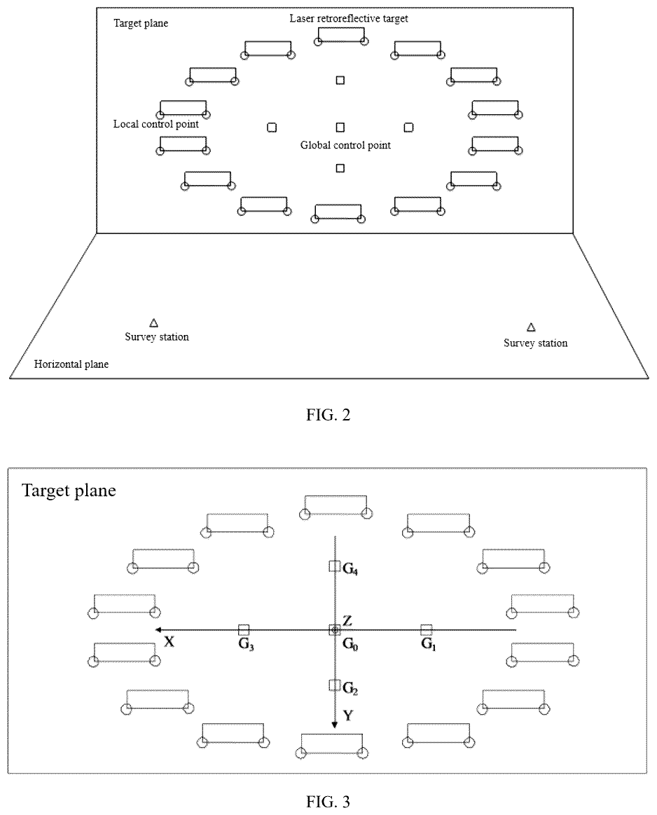

Referring to FIG. 1, the disclosure provides a method for calibrating structural errors in a conical scanning airborne bathymetric LiDAR system, including the following steps:
S1: deploying a plurality of global control points, a plurality of local control points, and a plurality of laser retroreflective targets on a target plane of a calibration field, and arranging two survey stations within the calibration field;
S2: establishing a global control coordinate system, and acquiring coordinates of the plurality of global control points in the global control coordinate system using a total station;
S3: determining, based on the coordinates of the plurality of global control points in the global control coordinate system, coordinates of the two survey stations in the global control coordinate system via a forward resection method and a trigonometric leveling method;
S4: acquiring, based on the coordinates of the two survey stations in the global control coordinate system, coordinates of the plurality of local control points and a center of an airborne bathymetric LiDAR reflector in the global control coordinate system using a forward intersection method and a trigonometric leveling method;
S5: acquiring slope distances from the center of the airborne bathymetric LiDAR reflector to laser footprints on the plurality of retroreflective targets and drive motor rotation angles using the conical scanning airborne bathymetric LiDAR system;
S6: acquiring, based on the coordinates of the plurality of local control points in the global control coordinate system, coordinates of the laser footprints in the global control coordinate system using the total station;
S7: constructing an error equation according to the slope distances, the drive motor rotation angles, and the coordinates of the laser footprints in the global control coordinate system, based on displacement and rotational geometric relationships between a laser scanning reference coordinate system and the global control coordinate system; and
S8: iteratively solving the error equation using a least-squares adjustment of indirect observation principle to derive structural error values of the conical scanning airborne bathymetric LiDAR system.

The step S1 specifically includes the following steps.

The target plane of the calibration field is oriented vertically. A point, labeled as G₀, is selected on the target plane to deploy the plurality of global control points, the plurality of global control points greater than 1 are uniformly distributed around the point G₀ in all directions, and one total station reflector shall be posted on each global control point. The plurality of laser retroreflective targets greater than 7 each in a rectangular shape are uniformly distributed around the plurality of global control points in all directions. One local control point is deployed at each of a bottom-left corner and a bottom-right corner of each laser retroreflective target, and one total station reflector shall be posted on each local control point. The two survey stations are arranged on a level ground in a front of the target plane of the calibration field, with one survey station of the two survey stations positioned on a left side and another of the two survey stations on a right side. The number of global control points should be more than 2 to ensure the accuracy of resection. The error equation has 8 undetermined parameters, and more than 7 equations need to be listed, so the number of laser retroreflective targets should be more than 7 to obtain more than data of 7 laser footprints. Because the scanning mode of the laser radar is conical scanning and the scanning track is ellipse, the layout of the laser retroreflective targets should be close to the ellipse, so that the laser scanning track falls on the laser retroreflective targets evenly.

For example, the calibration filed constructed in this embodiment has 5 global control points, 14 laser retroreflective targets, 28 local control points and 2 survey stations.

The step S2 specifically includes the following steps.

The global control coordinate system is established with the point G₀ as a coordinate origin, a horizontal direction as an X-axis, a vertical direction as a Y-axis, and a Z-axis forming a right-handed system with the X-axis and the Y-axis. A first global control point of the plurality of global control points is labeled as G₁. The total station is set at an unobstructed location, leveled, and making a center of the total station as O. The total station is aligned with the point G₀ for observation, recording a horizontal distance S₁ and a height difference H₁ between the center O and the point G₀, that is, OG₀. A horizontal circle of the total station is zeroed, then the total station is aligned with the first global control point G₁ for observation, recording a horizontal distance S₂ and a height difference H₂ between the center O and the first global control point G₁, that is, OG₁, and a horizontal angle α among the point G₀, the center O, and the first global control point G₁, that is, G₀OG₁. The coordinates of the first global control point G₁ in the global control coordinate system are calculated using:

$$\{ \begin{matrix}x = \pm \sqrt{{S}_{1}^{2} + {S}_{2}^{2} - 2 \times {S}_{1} \times {S}_{2} \times cos ( α )} \\ y = \pm \vert {H}_{2} - {H}_{1} \vert \\ z = 0\end{matrix} ; \qquad ( 1 )$$

where ± depends on a position of a point Gᵢ in the global control coordinate system. For example, when the point Gᵢ is located in a first quadrant of the global control coordinate system, both x and y take positive values; and when the point Gᵢ is located in a second quadrant of the global control coordinate system, x takes a negative value and y take a positive value.

Similarly, the above steps are repeated by aligning the total station with other global control points of the plurality of global control points, recording horizontal distances, height differences, and horizontal angles of the other global control points of the plurality of global control points to substitute into the formula (1) to thereby calculate the coordinates of each global control point in the global control coordinate system.

For example, the global control coordinate system established in this embodiment is described with reference to FIG. 3, in which the X-axis is horizontally leftward, the Y-axis is vertically downward, and the Z-axis is vertically forward of the target plane, and the coordinates of each global control point are shown in Table 1.

TABLE 1
(unit: meter abbreviated as m)

| Number | x | y | z |
|---|---|---|---|
| G₀ | 0 | 0 | 0 |
| G₁ | −0.962 | −0.010 | 0 |
| G₂ | 0 | 0.652 | 0 |
| G₃ | 0.963 | −0.013 | 0 |
| G₄ | 0 | −0.661 | 0 |

The step S3 specifically includes the following steps.

Firstly, the total station is set up at the position of the survey station Z₁. After centering and leveling, based on the x and z coordinates of the global control points in the global control coordinate system, the plane coordinates (x and z coordinates) of the survey station Z₁ in the global control coordinate system are obtained by using the forward resection method. Then, based on the y coordinate of the global control point G₀, the y coordinate of the survey station Z₁ in the global control coordinate system are obtained by the trigonometric leveling method. Similarly, the coordinates of the survey station Z₂ in the global control coordinates are obtained.

For example, the coordinates of the survey stations of this embodiment are shown in Table 2.

TABLE 2
(unit: m)

| Number | x | y | z |
|---|---|---|---|
| Z₁ | −2.296 | 1.916 | 5.271 |
| Z₂ | 2.737 | 1.892 | 5.317 |

The step S4 specifically includes the following steps.

Firstly, based on the x and z coordinates of the survey stations Z₁ and Z₂ in the global control coordinate system, the x and z coordinates of the local control points and the center of the airborne bathymetric LiDAR reflector (i.e., reflector center) in the global control coordinate system are obtained in turn by using the forward intersection method. Then, based on the y-coordinate of the station Z₂, the y-coordinates of the local control points and the reflector center in the global control coordinate system are obtained in turn by using the trigonometric leveling method.

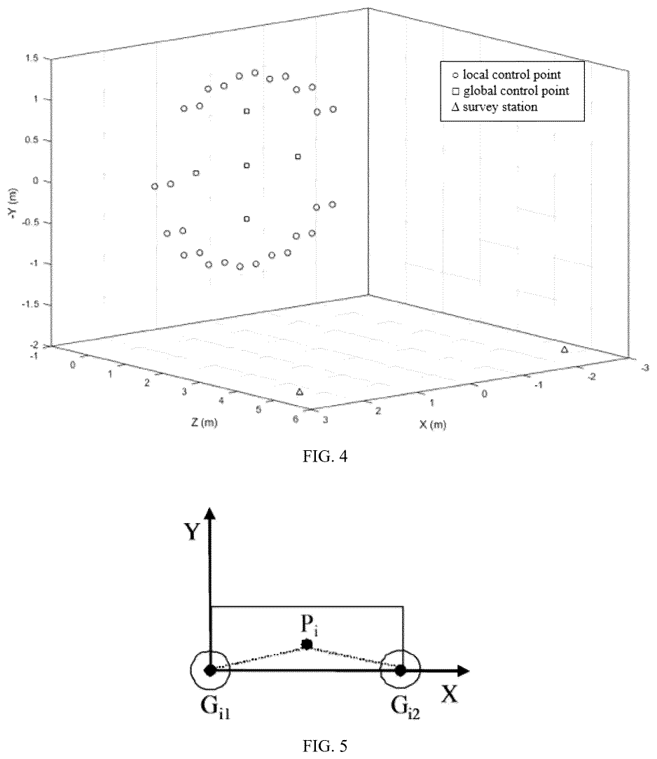

For example, the coordinate distribution of the local control points in this embodiment is described with reference to FIG. 4. There are 28 local control points in total, which are distributed in an ellipse-like manner as a whole.

The step S5 specifically includes the following steps.

A transceiver device and a rotating reflector scanning device of the LiDAR are turned off, and the reflector is manually rotated. When the laser footprints fall on the laser retroreflective targets, the transceiver device is turned on, the waveform data is collected and the waveform detection is carried out to obtain the laser propagation slope distance. At the same time, the drive motor rotation angles are recorded and the positions of the laser footprints are labeled. Continue to rotate the reflector so that the laser footprints fall onto each laser retroreflective target in turn, and the slope distance of each laser footprint and the drive motor rotation angle are obtained in turn and labeled.

The step S6 specifically includes the following steps.

Assuming one laser footprint of the laser footprints falls on an i-th laser retroreflective target of plurality of laser retroreflective targets, the one laser footprint of the laser footprints is labeled as Pᵢ, local control points of the plurality of local control points at a bottom-left corner and a bottom-right corner of each laser retroreflective target are labeled as Gᵢ₁ and Gᵢ₂, respectively. A Cartesian coordinate system is illustrated with reference to FIG. 5, the Cartesian coordinate system is established with the local control point Gᵢ₁ as an origin, Gᵢ₁Gᵢ₂ as an X-axis direction, and a direction perpendicular to the X-axis upward as a Y-axis direction.

The total station is set at an unobstructed location, leveled, and making a center of the total station as O. The total station is aligned with the local control point Gᵢ₁ for observation, recording a horizontal distance S₁ and a height difference H₁ between the center O and the local control point Gᵢ₁, that is, OGᵢ₁. A horizontal circle of the total station is zeroed, then the total station is aligned with the laser footprint as Pᵢ for observation, recording a horizontal distance S₂ and a height difference H₂ between the center O and the laser footprint Pᵢ, that is, OPᵢ, and a horizontal angle αᵢ among the local control point Gᵢ₁, the center O, and the laser footprint Pᵢ, that is, Gᵢ₁OPᵢ. The total station is aligned with the local control point Gᵢ₂ for observation, recording a horizontal distance S₃ and a height difference H₃ between the center O and the local control point Gᵢ₂, that is, OGᵢ₂, and a horizontal angle α₂ among the local control point Gᵢ₁, the center O, and the local control point Gᵢ₂, that is, Gᵢ₁OGᵢ₂.

A distance Gᵢ₁Gᵢ₂ between the local control point Gᵢ₁ and the local control point Gᵢ₂ is calculated:

$${S}_{{G}_{i 1} {G}_{i 2}} = \sqrt{{( {x}_{{G}_{i 1}} - {x}_{{G}_{i 2}} )}^{2} + {( {y}_{{G}_{i 1}} - {y}_{{G}_{i 2}} )}^{2}}$$

where (x_{G}_{ᵢ₁}, y_{G}_{ᵢ₁}) and (x_{G}_{ᵢ₂}, y_{G}_{ᵢ₂}) are x, y coordinates of the local control point Gᵢ₁ and the local control point Gᵢ₂ in the global control coordinate system.

A distance Gᵢ₁Pᵢ between the local control point Gᵢ₁ and the laser footprint Pᵢ is calculated:

$${S}_{{G}_{i 1} {P}_{i}} = \sqrt{{( {H}_{2} - {H}_{1} )}^{2} + {S}_{1}^{2} + {S}_{2}^{2} - 2 \times {S}_{1} \times {S}_{2} \times cos ( {α}_{1} )} .$$

A distance PᵢGᵢ₂ between the laser footprint Pᵢ and the local control point Gᵢ₂ is calculated:

$${S}_{{P}_{i} {G}_{i 2}} = \sqrt{{( {H}_{2} - {H}_{3} )}^{2} + {S}_{2}^{2} + {S}_{3}^{2} - 2 \times {S}_{2} \times {S}_{3} \times cos ( {α}_{2} - {α}_{1} )} .$$

An angle ∠PᵢGᵢ₂Gᵢ₂ based on S_{G}_{ᵢ₁}_{G}_{ᵢ₂}, S_{G}_{ᵢ₁}_{P}_{ᵢ}, and S_{P}_{ᵢ}_{G}_{ᵢ₂} is calculated:

$$∠ {P}_{i} {G}_{i 1} {G}_{i 2} = {cos}^{- 1} ( ( {S}_{{G}_{i 1} {P}_{i}}^{2} + {S}_{{G}_{i 1} {G}_{i 2}}^{2} - {S}_{{P}_{i} {G}_{i 2}}^{2} ) ) / ( 2 \times {S}_{{G}_{i 1} {P}_{i}} \times {S}_{{G}_{i 1} {G}_{i 2}} ) )$$

Coordinates of the laser footprints in the Cartesian coordinate system based on the angle ∠PᵢGᵢ₁Gᵢ₂ are calculated:

$$\{ \begin{matrix}{x}^{′} = {S}_{{G}_{i 1} {P}_{i}} \times {cos ( ∠ {P}_{i} {G}_{i 1} {G}_{i 2} )}_{} \\ {y}^{′} = {S}_{{G}_{i 1} {P}_{i}} \times sin ( ∠ {P}_{i} {G}_{i 1} {G}_{i 2} ) .\end{matrix}$$

The coordinates of the laser footprints in the Cartesian coordinate system are converted to the global control coordinate system:

$$\{ \begin{matrix}x = {x}_{{G}_{i 1}} + {x}^{′} \times cos ( β ) - {y}^{′} \times sin ( β ) \\ y = {y}_{{G}_{i 1}} + {x}^{′} \times sin ( β ) + {y}^{′} \times cos ( β ) \\ z = 0\end{matrix} ;$$

$$where β = {tan}^{- 1} ( ( {y}_{{G}_{i 2}} - {y}_{{G}_{i 1}} ) / ( {x}_{{G}_{i 2}} - {x}_{{G}_{i 1}} ) ) .$$

The step S7 specifically includes the following steps.

A laser scanning reference coordinate system is established with the center of the airborne bathymetric LiDAR reflector as an origin, a carrier flight direction as a Y-axis, a Z-axis vertically upward, and an X-axis forming a right-handed system with the Y-axis and the Z-axis. Theoretically, an incident laser beam and a drive motor rotation shaft lie in a same plane, an XZ-plane, with the incident laser beam horizontally incident along a negative direction of the X-axis toward the center of the airborne bathymetric LiDAR reflector. The conical scanning airborne bathymetric LiDAR system is rotated to align the X-axis, the Y-axis, and the Z-axis of the laser scanning reference coordinate system with the X-axis, the Y-axis, and the Z-axis of the global control coordinate system.

A slope distance of the laser footprints is defined as S, the drive motor rotation angles is 0, and (μ, Δω, Δη, ΔS, Δθ) are parameters of the structural errors, with p representing an angle between the incident laser beam and the X-axis of the laser reference coordinate system, Δω representing an angular error between the incident laser beam and the drive motor rotation shaft, Δη representing an angular error between a reflector normal and the drive motor rotation shaft, ΔS representing a laser ranging error, and Δθ representing a drive motor rotation angle error. Considering a horizontal oblique incidence of the incident laser beam onto the center of the airborne bathymetric LiDAR reflector, a direction vector of the incident laser beam in the laser scanning reference coordinate system is:

$${A}_{in} = [ \begin{matrix}- cos µ \\ - sin µ \\ 0\end{matrix} ] .$$

An angle between the incident laser beam and the drive motor rotation shaft is defined as ω, accounting for the angular error Δω, the laser scanning reference coordinate system is rotated counterclockwise along the Y-axis of the laser scanning reference coordinate system by ω+Δω to align the Z-axis of the laser scanning reference coordinate system with the drive motor rotation shaft, thereby establishing a laser scanning auxiliary coordinate system. A direction vector of the incident laser beam in the laser scanning auxiliary coordinate system is:

$${A}_{in}^{′} = [ \begin{matrix}cos ( ω + Δ ω ) & 0 & sin ( ω + Δ ω ) \\ 0 & 1 & 0 \\ - sin ( ω + Δ ω ) & 0 & cos ( ω + Δ ω )\end{matrix} ] \cdot {A}_{in} .$$

An angle between the reflector normal and the drive motor rotation shaft is defined as η, accounting for the angular error Δη and the drive motor rotation angle error Δθ, a direction vector of the reflector normal in the laser scanning auxiliary coordinate system is:

$$N = [ \begin{matrix}{N}_{x} \\ {N}_{y} \\ {N}_{z}\end{matrix} ] = [ \begin{matrix}sin ( η + Δ η ) cos ( θ + Δ θ ) \\ sin ( η + Δ η ) sin ( θ + Δ θ ) \\ - cos ( η + Δ η )\end{matrix} ] .$$

The direction vector A′ᵢₙ is reversed and then rotated by 180° around N to obtain a direction vector of a reflected beam in the laser scanning auxiliary coordinate system as follows:

$${A}_{out}^{′} = [ \begin{matrix}2 {N}_{x}^{2} - 1 & 2 {N}_{x} {N}_{y} & 2 {N}_{x} {N}_{z} \\ 2 {N}_{x} {N}_{y} & 2 {N}_{y}^{2} - 1 & 2 {N}_{y} {N}_{z} \\ 2 {N}_{x} {N}_{z} & 2 {N}_{y} {N}_{z} & 2 {N}_{z}^{2} - 1\end{matrix} ] \cdot - {A}_{in}^{′} .$$

The direction vector A′ₒᵤₜ is rotated clockwise around a Y-axis of the laser scanning auxiliary coordinate system by ω+Δω to obtain a direction vector of the reflected beam in the laser scanning reference coordinate system as follows:

$${A}_{out} = [ \begin{matrix}cos ( ω + Δ ω ) & 0 & - sin ( ω + Δ ω ) \\ 0 & 1 & 0 \\ sin ( ω + Δ ω ) & 0 & cos ( ω + Δ ω )\end{matrix} ] \cdot {A}_{out}^{′} .$$

A propagation speed of light in air is defined as c, a propagation time of a laser from the center of the airborne bathymetric LiDAR reflector to the laser footprint points is measured through waveform detection as Δt, accounting for the laser ranging error ΔS, a slope distance of laser propagation in air is calculated as:

$${S}^{′} + S + Δ S = 1 / 2 \times c \times Δ t + Δ S .$$

Thus, the coordinates of the laser footprints in the laser scanning reference coordinate system are:

$$[ \begin{matrix}{X}_{L} \\ {Y}_{L} \\ {Z}_{L}\end{matrix} ] = [ \begin{matrix}{f}_{x} ( S , θ , µ , Δ ω , Δ η , Δ S , Δ θ ) \\ {f}_{y} ( S , θ , µ , Δ ω , Δ η , Δ S , Δ θ ) \\ {f}_{z} ( S , θ , µ , Δ ω , Δ η , Δ S , Δ θ )\end{matrix} ] = {S}^{′} \cdot {A}_{out} .$$

Specifically, fₓ, f_{y} and f_{z} are formulas of an error-integrated positioning model for x, y, and z coordinates of the conical scanning airborne bathymetric LiDAR system.

The coordinates of the center of the airborne bathymetric LiDAR reflector in the global control coordinate system are defined as (ΔX, ΔY, ΔZ), and the coordinates of the laser footprints in the global control coordinate system are calculated using:

$$[ \begin{matrix}{X}_{G} \\ {Y}_{G} \\ {Z}_{G}\end{matrix} ] = R ( α , β , γ ) [ \begin{matrix}{X}_{L} \\ {Y}_{L} \\ {Z}_{L}\end{matrix} ] + [ \begin{matrix}Δ X \\ Δ Y \\ Δ Z\end{matrix} ] = F ( S , θ , µ , Δ ω , Δ η , Δ S , Δ θ , α , β , γ ) .$$

where F is a calibration model with eight undetermined parameters (μ, Δω, Δη, ΔS, Δθ, α, β, γ), and R(α, β, γ) is a rotation matrix from the laser scanning reference coordinate system to the global control coordinate system, defined as:

$$R ( α , β , γ ) = [ \begin{matrix}cos αcos γ + sin α sin β sin γ & sin γ cos β & sin α cos γ - cos α sin β sin γ \\ \text{} - cos αsin γ + sin α sin β cos γ & cos γ cos β & - sin α sin γ - cos α sin β cos γ \\ - sin α cos β & sin β & cos α cos β\end{matrix} ] ;$$

where (α, β, γ) are rotation angles around the X-axis, the Y-axis, and the Z-axis of the global control coordinate system respectively.

The calibration model is linearized to derive the error equation:

$$[ \begin{matrix}{V}_{x} \\ {V}_{y} \\ {V}_{z}\end{matrix} ] = ( \frac{\partial F}{\partial μ} ) δ μ + ( \frac{\partial F}{\partial Δ ω} ) δ Δ ω + ( \frac{\partial F}{\partial Δ η} ) δ Δ η + ( \frac{\partial F}{\partial Δ S} ) δ Δ S + ( \frac{\partial F}{\partial Δ θ} ) δ Δ θ + ( \frac{\partial F}{\partial α} ) δ α + ( \frac{\partial F}{\partial β} ) δ β + ( \frac{\partial F}{\partial γ} ) δ γ - [ \begin{matrix}{X}_{G} - ( {X}_{G} ) \\ {Y}_{G} - ( {Y}_{G} ) \\ {Z}_{G} - ( {Z}_{G} )\end{matrix} ] ;$$

where (X_{G}, Y_{G}, Z_{G}) are the coordinates of the laser footprints in the global control coordinate system measured using the total station, and ((X_{G}), (Y_{G}), (Z_{G})) are the coordinates of the laser footprints in the global control coordinate system calculated by substituting the slope distance, the drive motor rotation angles, and approximate values of the undetermined parameters into the calibration model.

The step S8 is specifically includes the following steps.

The error equation is expressed in a matrix form: V=BX−L;
where X=[δμ, δΔω, δΔη, δΔS, δΔθ, δα, δβ, δγ]^{T}.

Assuming a total number of the laser footprints as n laser footprints, the matrix is expressed as:

$$V = [ \begin{matrix}{V}_{1} \\ {V}_{2} \\ ⋮ \\ {V}_{i} \\ ⋮ \\ {V}_{n}\end{matrix} ] , B = [ \begin{matrix}{B}_{1} & 0 & … & 0 \\ 0 & {B}_{2} & … & 0 \\ ⋮ & ⋮ & {B}_{i} & ⋮ \\ 0 & 0 & … & {B}_{n}\end{matrix} ] , L = [ \begin{matrix}{L}_{1} \\ {L}_{2} \\ ⋮ \\ {L}_{i} \\ ⋮ \\ {L}_{n}\end{matrix} ] ;$$

where i represents an i-th laser footprint, and for each laser footprint:

$${V}_{i} = [ \begin{matrix}{V}_{ix} \\ {V}_{iy} \\ {V}_{iz}\end{matrix} ] ;$$

$${B}_{i} = [ \begin{matrix}\frac{\partial {F}_{x}}{\partial μ} & \frac{\partial {F}_{x}}{\partial Δ ω} & \frac{\partial {F}_{x}}{\partial Δ η} & \frac{\partial {F}_{x}}{\partial Δ S} & \frac{\partial {F}_{x}}{\partial Δ θ} & \frac{\partial {F}_{x}}{\partial α} & \frac{\partial {F}_{x}}{\partial β} & \frac{\partial {F}_{x}}{\partial γ} \\ \frac{\partial {F}_{y}}{\partial μ} & \frac{\partial {F}_{y}}{\partial Δ ω} & \frac{\partial {F}_{y}}{\partial Δ η} & \frac{\partial {F}_{y}}{\partial Δ S} & \frac{\partial {F}_{y}}{\partial Δ θ} & \frac{\partial {F}_{y}}{\partial α} & \frac{\partial {F}_{y}}{\partial β} & \frac{\partial {F}_{y}}{\partial γ} \\ \frac{\partial {F}_{z}}{\partial μ} & \frac{\partial {F}_{z}}{\partial Δ ω} & \frac{\partial {F}_{z}}{\partial Δ η} & \frac{\partial {F}_{z}}{\partial Δ S} & \frac{\partial {F}_{z}}{\partial Δ θ} & \frac{\partial {F}_{z}}{\partial α} & \frac{\partial {F}_{z}}{\partial β} & \frac{\partial {F}_{z}}{\partial γ}\end{matrix} ] ;$$

$${L}_{i} = [ \begin{matrix}{X}_{iG} - ( {X}_{iG} ) \\ {Y}_{iG} - ( {Y}_{iG} ) \\ {Z}_{iG} - ( {Z}_{iG} )\end{matrix} ] .$$

A normal equation is formulated based on the least-squares adjustment of indirect observation principle as:

$${B}^{T} BX = {B}^{T} L .$$

The above normal equation is solved as:

$$X = {( {B}^{T} B )}^{- 1} {B}^{T} L .$$

The coordinates of the laser footprints in the global control coordinate system (X_{G}, Y_{G}, Z_{G}), the slope distance S, the drive motor rotation angles θ, and approximate values of the undetermined parameters (μ, Δω, Δη, ΔS, Δθ, α, β, γ) are substituted into the above formulas to derive correction parameters of the undetermined parameters as ( [symbol] ).

The undetermined parameters are updated based on the correction parameters ( [symbol] , [symbol] ) as:

$$μ + \dot{μ} \to μ ;$$

$$Δ ω + \dot{Δ ω} \to Δ ω ;$$

$$Δ η + \dot{Δ η} \to Δ η ;$$

$$Δ S + \dot{Δ S} \to Δ S ;$$

$$Δ θ + \dot{Δ θ} \to Δ θ ;$$

$$α + \dot{α} \to α ;$$

$$β + \dot{β} \to β ;$$

$$γ + \dot{γ} \to γ .$$

The coordinates of the laser footprints ((X_{G}), (Y_{G}), (Z_{G})) in the global control coordinate system are recalculated using the undetermined parameters (μ, Δω, Δη, ΔS, Δθ, α, β, γ) after the updating. Then, a matrix B and a matrix L are recalculated. The normal equation of the error equation is solved via the least-squares adjustment of indirect observation principle to obtain new correction parameters ( [symbol] ). The above steps are repeated iteratively until absolute values of all correction parameters are less than 0.001.

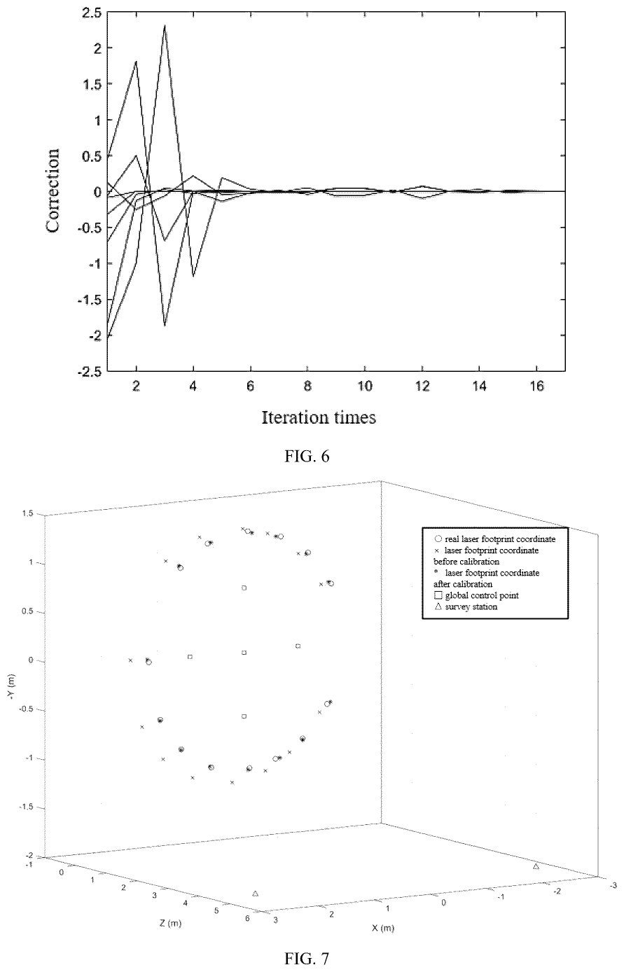

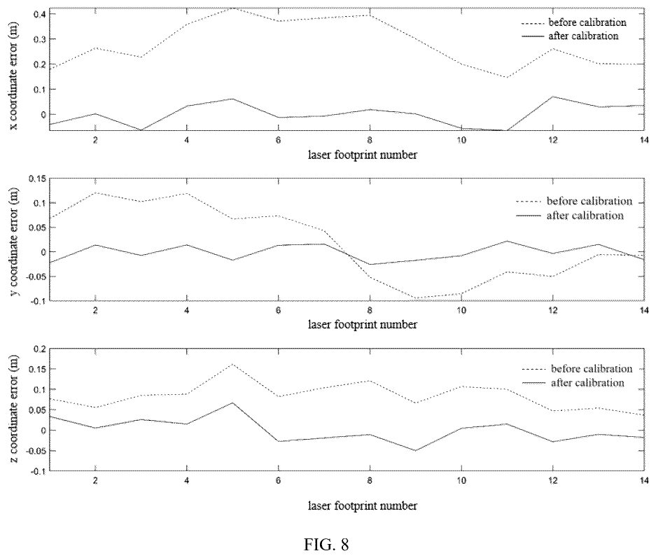

For example, the iterative solution process of the error equation is described with reference to FIG. 6. After 17 iterations, the absolute value of the correction parameter of each undetermined parameter has converged to be less than 0.001, and the initial and final values of each undetermined parameter are shown in Table 3. FIG. 7 and FIG. 8 are used to illustrate the structural error calibration results. Compared with that before calibration, the coordinates of laser footprints measured by calibrated LiDAR are closer to those measured by total station (real laser footprint coordinates), and the calculation errors of x, y and z coordinates are significantly reduced. The average absolute errors before and after calibration are 0.144 m and 0.025 m, respectively, and the error decreases by 82.814%.

TABLE 3

| Parameters | μ | Δω | Δη | ΔS | |
|---|---|---|---|---|---|
| Initial value | 0° | 0° | 0° | 0 | m |
| Final value | 0.076° | −0.7475° | −0.311° | 0.088 | m |

| Parameters | Δθ | α | β | γ |
|---|---|---|---|---|
| Initial value | 0° | −3.500° | 2.500° | 0° |
| Final value | −1.865° | −3.678° | 2.565° | 0.332° |

### Embodiment 2

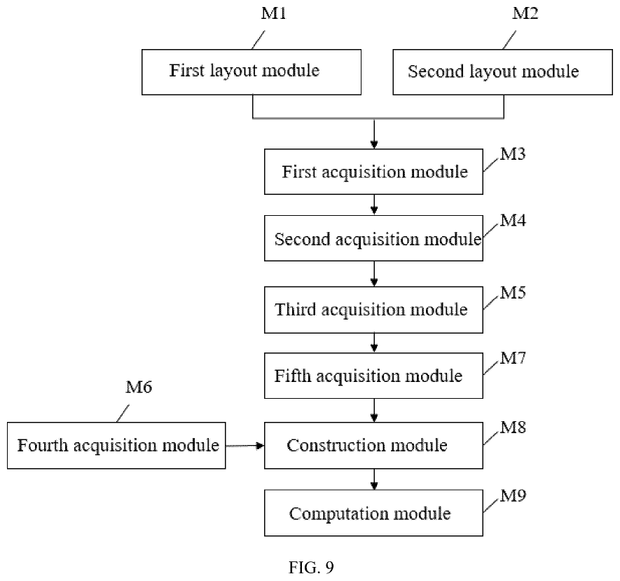

Referring to FIG. 9, an apparatus for calibrating structural errors in a conical scanning airborne bathymetric LiDAR system, including: a first layout module M1 (also referred to as first deployment module M1), a second layout module M2 (also referred to as second deployment module M2), a first acquisition module M3, a second acquisition module M4, a third acquisition module M5, a fourth acquisition module M6, a fifth acquisition module M7, a construction module M8, and a computation module M9.

The first layout module is configured to deploy a plurality of global control points, a plurality of local control points, and a plurality of laser retroreflective targets on a target plane of a calibration field, and arrange two survey stations within the calibration field.

The second layout module is configured to deploy the conical scanning airborne bathymetric LiDAR system and a total station within a calibration field.

The first acquisition module is configured to acquire coordinates of the plurality of global control points in a global control coordinate system.

The second acquisition module is configured to acquire coordinates of the survey stations in the global control coordinate system.

The third acquisition module is configured to acquire coordinates of the plurality of local control points and a center of an airborne bathymetric LiDAR reflector in the global control coordinate system.

The fourth acquisition module is configured to acquire slope distances from the center of the airborne bathymetric LiDAR reflector to laser footprints on the plurality of retroreflective targets and drive motor rotation angles.

The fifth acquisition module is configured to acquire coordinates of the laser footprints in the global control coordinate system.

The construction module is configured to construct an error equation.

The computation module is configured to solve the error equation to derive structural error values of the conical scanning airborne bathymetric LiDAR system.

In an embodiment, each of the first layout module, the second layout module, the first acquisition module, the second acquisition module, the third acquisition module, the fourth acquisition module, the fifth acquisition module, the construction module, and the computation module is embodied by at least one processor and at least one memory coupled to the at least one processor, and the at least one memory stores computer programs executable by the at least one processor.

The above embodiments have further described the purposes, technical solutions and advantages of the disclosure in detail. It should be understood that the above embodiments are only specific embodiments of the disclosure, and are not intended to limit the disclosure. Any person skilled in the art is within the scope disclosed in the disclosure. Any modifications, equivalents, changes, and the like that may readily occur are intended to be included within the scope of the disclosure.

What is claimed is:

1. A method for calibrating structural errors in a conical scanning airborne bathymetric light detection and ranging (LiDAR) system, comprising:
deploying a plurality of global control points, a plurality of local control points, and a plurality of laser retroreflective targets on a target plane of a calibration field, and arranging two survey stations within the calibration field;
establishing a global control coordinate system, and acquiring coordinates of the plurality of global control points in the global control coordinate system using a total station;
determining, based on the coordinates of the plurality of global control points in the global control coordinate system, coordinates of the two survey stations in the global control coordinate system via a forward resection method and a trigonometric leveling method;
acquiring, based on the coordinates of the two survey stations in the global control coordinate system, coordinates of the plurality of local control points and a center of an airborne bathymetric LiDAR reflector in the global control coordinate system using a forward intersection method and a trigonometric leveling method;
acquiring slope distances from the center of the airborne bathymetric LiDAR reflector to laser footprints on the plurality of retroreflective targets and drive motor rotation angles using the conical scanning airborne bathymetric LiDAR system;
acquiring, based on the coordinates of the plurality of local control points in the global control coordinate system, coordinates of the laser footprints in the global control coordinate system using the total station;
constructing an error equation according to the slope distances, the drive motor rotation angles, and the coordinates of the laser footprints in the global control coordinate system, based on displacement and rotational geometric relationships between a laser scanning reference coordinate system and the global control coordinate system; and
iteratively solving the error equation using a least-squares adjustment of indirect observation principle to derive structural error values of the conical scanning airborne bathymetric LiDAR system.

2. The calibration method as claimed in claim 1, wherein the deploying a plurality of global control points, a plurality of local control points, and a plurality of laser retroreflective targets on a target plane of a calibration field, and arranging two survey stations within the calibration field comprises:
orienting the target plane of the calibration field vertically;
selecting a point, labeled as G₀, on the target plane to deploy the plurality of global control points, and uniformly distributing the plurality of global control points greater than 1 around the point G₀ in all directions;
uniformly distributing the plurality of laser retroreflective targets greater than 7 each in a rectangular shape around the plurality of global control points in all directions;
deploying one local control point at each of a bottom-left corner and a bottom-right corner of each laser retroreflective target; and
arranging the two survey stations on a level ground in a front of the target plane of the calibration field, with one survey station of the two survey stations positioned on a left side and another of the two survey stations on a right side.

3. The calibration method as claimed in claim 1, wherein the establishing a global control coordinate system, and acquiring coordinates of the plurality of global control points in the global control coordinate system using a total station comprises:
establishing the global control coordinate system with the point G₀ as a coordinate origin, a horizontal direction as an X-axis, a vertical direction as a Y-axis, and a Z-axis forming a right-handed system with the X-axis and the Y-axis;
labeling a first global control point of the plurality of global control points as G₁;
setting up the total station at an unobstructed location, leveling the total station, and making a center of the total station as O;
aligning the total station with the point G₀ for observation, recording a horizontal distance S₁ and a height difference H₁ between the center O and the point G₀, that is, OG₀;
zeroing a horizontal circle of the total station, then aligning the total station with the first global control point G₁ for observation, recording a horizontal distance S₂ and a height difference H₂ between the center O and the first global control point G₁, that is, OG₁, and a horizontal angle α among the point G₀, the center O, and the first global control point G₁, that is, G₀OG₁;
calculating the coordinates of the first global control point G₁ in the global control coordinate system using:
$$\{ \begin{matrix}x = \pm \sqrt{{S}_{1}^{2} + {S}_{2}^{2} - 2 \times {S}_{1} \times {S}_{2} \times cos ( α )} \\ y = \pm \vert {H}_{2} - {H}_{1} \vert \\ z = 0\end{matrix} ; \qquad ( 1 )$$
where ± depends on a position of a point Gᵢ in the global control coordinate system;
when the point Gᵢ is located in a first quadrant of the global control coordinate system, both x and y take positive values; when the point Gᵢ is located in a second quadrant of the global control coordinate system, x takes a negative value and y take a positive value; and
repeating the above steps by aligning the total station with other global control points of the plurality of global control points, recording horizontal distances, height differences, and horizontal angles of the other global control points of the plurality of global control points to substitute into the formula (1) to thereby calculate the coordinates of each global control point in the global control coordinate system.

4. The calibration method as claimed in claim 1, wherein the acquiring, based on the coordinates of the plurality of local control points in the global control coordinate system, coordinates of the laser footprints in the global control coordinate system using the total station comprises:
assuming one laser footprint of the laser footprints falls on an i-th laser retroreflective target of plurality of laser retroreflective targets, labeling the one laser footprint of the laser footprints as Pᵢ, labeling local control points of the plurality of local control points at a bottom-left corner and a bottom-right corner of each laser retroreflective target as Gᵢ₁ and Gᵢ₂, respectively; establishing a Cartesian coordinate system with the local control point Gᵢ₁ as an origin, Gᵢ₁Gᵢ₂ as an X-axis direction, and a direction perpendicular to the X-axis upward as a Y-axis direction;
setting up the total station at an unobstructed location, leveling the total station, and making a center of the total station as O; aligning the total station with the local control point Gᵢ₁ for observation; recording a horizontal distance S₁ and a height difference H₁ between the center O and the local control point Gᵢ₁, that is, OGᵢ₁; zeroing a horizontal circle of the total station, then aligning the total station with the laser footprint as Pᵢ for observation; recording a horizontal distance S₂ and a height difference H₂ between the center O and the laser footprint Pᵢ, that is, OPᵢ, and a horizontal angle α₁ among the local control point Gᵢ₁, the center O, and the laser footprint Pᵢ, that is, Gᵢ₁OPᵢ; aligning the total station with the local control point Gᵢ₂ for observation; recording a horizontal distance S₃ and a height difference H₃ between the center O and the local control point Gᵢ₂, that is, OGᵢ₂, and a horizontal angle α₂ among the local control point Gᵢ₁, the center O, and the local control point Gᵢ₂, that is, Gᵢ₁OGᵢ₂;
calculating a distance Gᵢ₁Gᵢ₂ between the local control point Gᵢ₁ and the local control point Gᵢ₂:
$${S}_{{G}_{i 1} {G}_{i 2}} = \sqrt{{( {x}_{{G}_{i 1}} - {x}_{{G}_{i 2}} )}^{2} + {( {y}_{{G}_{i 1}} - {y}_{{G}_{i 2}} )}^{2}} ;$$
where (x_{G}_{ᵢ₁}, y_{G}_{ᵢ₁}) and (x_{G}_{ᵢ₂}, y_{G}_{ᵢ₂}) are x, y coordinates of the local control point Gᵢ₁ and the local control point Gᵢ₂ in the global control coordinate system;
calculating a distance Gᵢ₁Pᵢ between the local control point Gᵢ₁ and the laser footprint Pᵢ:
$${S}_{{G}_{i 1} {P}_{i}} = \sqrt{{( {H}_{2} - {H}_{1} )}^{2} + {S}_{1}^{2} + {S}_{2}^{2} - 2 \times {S}_{1} \times {S}_{2} \times cos ( {α}_{1} )} ;$$
calculating a distance PᵢGᵢ₂ between the laser footprint Pᵢ and the local control point Gᵢ₂:
$${S}_{{P}_{i} {G}_{i 2}} = \sqrt{{( {H}_{2} - {H}_{3} )}^{2} + {S}_{2}^{2} + {S}_{3}^{2} - 2 \times {S}_{2} \times {S}_{3} \times cos ( {α}_{2} - {α}_{1} )} ;$$
calculating an angle ∠PᵢGᵢ₁Gᵢ₂ based on S_{G}_{ᵢ₁}_{G}_{ᵢ₂}, S_{G}_{ᵢ₁}_{P}_{ᵢ}, and S_{P}_{ᵢ}_{G}_{ᵢ₂}:
$$∠ {P}_{i} {G}_{i 1} {G}_{i 2} = {cos}^{- 1} ( ( {S}_{{G}_{i 1} {P}_{i}}^{2} + {S}_{{G}_{i 1} {G}_{i 2}}^{2} - {S}_{{P}_{i} {G}_{i 2}}^{2} ) ) / ( 2 \times {S}_{{G}_{i 1} {P}_{i}} \times {G}_{{G}_{i 1} {G}_{i 2}} ) ) ;$$
calculating coordinates of the laser footprints in the Cartesian coordinate system based on the angle ∠PᵢGᵢ₁Gᵢ₂:
$$\{ \begin{matrix}{x}^{′} = {S}_{{G}_{i 1} {P}_{i}} \times cos ( ∠ {P}_{i} {G}_{i 1} {G}_{i 2} ) \\ {y}^{′} = {S}_{{G}_{i 1} {P}_{i}} \times sin ( ∠ {P}_{i} {G}_{i 1} {G}_{i 2} )\end{matrix} ;$$
converting the coordinates of the laser footprints in the Cartesian coordinate system to the global control coordinate system:
$$\{ \begin{matrix}x = {x}_{{G}_{i 1}} + {x}^{′} \times cos ( β ) - {y}^{′} \times sin ( β ) \\ x = {x}_{{G}_{i 1}} + {x}^{′} \times cos ( β ) - {y}^{′} \times sin ( β ) \\ z = 0\end{matrix} ;$$
$$where β = {tan}^{- 1} ( ( {y}_{{G}_{i 2}} - {y}_{{G}_{i 1}} ) / ( {x}_{{G}_{i 2}} - {x}_{{G}_{i 1}} ) ) .$$

5. The calibration method as claimed in claim 1, wherein the constructing an error equation according to the slope distances, the drive motor rotation angles, and the coordinates of the laser footprints in the global control coordinate system, based on displacement and rotational geometric relationships between a laser scanning reference coordinate system and the global control coordinate system comprises:
establishing a laser scanning reference coordinate system with the center of the airborne bathymetric LiDAR reflector as an origin, a carrier flight direction as a Y-axis, a Z-axis vertically upward, and an X-axis forming a right-handed system with the Y-axis and the Z-axis; rotating the conical scanning airborne bathymetric LiDAR system to align the X-axis, the Y-axis, and the Z-axis of the laser scanning reference coordinate system with the X-axis, the Y-axis, and the Z-axis of the global control coordinate system; wherein, theoretically, an incident laser beam and a drive motor rotation shaft lie in a same plane, an XZ-plane, with the incident laser beam horizontally incident along a negative direction of the X-axis toward the center of the airborne bathymetric LiDAR reflector;
defining a slope distance of the laser footprints as S, the drive motor rotation angles as θ, and calculating coordinates of the laser footprints in the laser reference coordinate system using:
$$[ \begin{matrix}{X}_{L} \\ {Y}_{L} \\ {Z}_{L}\end{matrix} ] = [ \begin{matrix}{f}_{x} ( S , θ , μ , Δ ω , Δ η , Δ S , Δ θ ) \\ {f}_{y} ( S , θ , μ , Δ ω , Δ η , Δ S , Δ θ ) \\ {f}_{z} ( S , θ , μ , Δ ω , Δ η , Δ S , Δ θ )\end{matrix} ] ;$$
where fₓ, f_{y} and f_{z} are formulas of an error-integrated positioning model for x, y, and z coordinates of the conical scanning airborne bathymetric LiDAR system, and (μ, Δω, Δη, ΔS, Δθ) are parameters of the structural errors, with μ representing an angle between the incident laser beam and the X-axis of the laser reference coordinate system, Δω representing an angular error between the incident laser beam and the drive motor rotation shaft, Δη representing an angular error between a reflector normal and the drive motor rotation shaft, ΔS representing a laser ranging error, and Δθ representing a drive motor rotation angle error;
defining the coordinates of the center of the airborne bathymetric LiDAR reflector in the global control coordinate system as (ΔX, ΔY, ΔZ), and calculating the coordinates of the laser footprints in the global control coordinate system using:
$$[ \begin{matrix}{X}_{G} \\ {Y}_{G} \\ {Z}_{G}\end{matrix} ] = R ( α , β , γ ) [ \begin{matrix}{X}_{L} \\ {Y}_{L} \\ {Z}_{L}\end{matrix} ] + [ \begin{matrix}Δ X \\ Δ Y \\ Δ Z\end{matrix} ] = F ( S , θ , μ , Δω , Δη , Δ S , Δθ , α , β , γ ) ;$$
where F is a calibration model with eight undetermined parameters (μ, Δω, Δη, ΔS, Δθ, α, β, γ), and R(α, β, γ) is a rotation matrix from the laser scanning reference coordinate system to the global control coordinate system, defined as:
$$R ( α , β , γ ) = [ \begin{matrix}cos α cos γ + sin α sin β sin γ & sin γ cos β & sin α cos γ - cos α sin β sin γ \\ - cos α sin γ + sin α sin β cos γ & cos γ cos β & - sin α sin γ - cos α sin βcosγ \\ - sin α cos β & sin β & cos α cos β\end{matrix} ] ;$$
where (α, β, γ) are rotation angles around the X-axis, the Y-axis, and the Z-axis of the global control coordinate system respectively;
linearizing the calibration model to derive the error equation:
$$[ \begin{matrix}{v}_{x} \\ {v}_{y} \\ {v}_{z}\end{matrix} ] = ( \frac{\partial F}{\partial μ} ) δμ + ( \frac{\partial F}{\partial Δω} ) δΔω + ( \frac{\partial F}{\partial Δη} ) δΔη + ( \frac{\partial F}{\partial Δ S} ) δΔ S + ( \frac{\partial F}{\partial Δθ} ) δΔθ + ( \frac{\partial F}{\partial α} ) δα + ( \frac{\partial F}{\partial β} ) δβ + ( \frac{\partial F}{\partial γ} ) δγ - [ \begin{matrix}{X}_{G} - ( {X}_{G} ) \\ {Y}_{G} - ( {Y}_{G} ) \\ {Z}_{G} - ( {Z}_{G} )\end{matrix} ] ;$$
where (X_{G}, Y_{G}, Z_{G}) are the coordinates of the laser footprints in the global control coordinate system measured using the total station, and ((X_{G}), (Y_{G}), (Z_{G})) are the coordinates of the laser footprints in the global control coordinate system calculated by substituting the slope distance, the drive motor rotation angles, and approximate values of the undetermined parameters into the calibration model.

6. The calibration method as claimed in claim 5, wherein the error-integrated positioning model of the conical scanning airborne bathymetric LiDAR system comprises:
considering a horizontal oblique incidence of the incident laser beam onto the center of the airborne bathymetric LiDAR reflector, a direction vector of the incident laser beam in the laser scanning reference coordinate system is:
$${A}_{in} = [ \begin{matrix}- cos μ \\ - sin μ \\ 0\end{matrix} ] ;$$
defining an angle between the incident laser beam and the drive motor rotation shaft as ω, accounting for the angular error Δω, rotating the laser scanning reference coordinate system counterclockwise along the Y-axis of the laser scanning reference coordinate system by ω+Δω to align the Z-axis of the laser scanning reference coordinate system with the drive motor rotation shaft, thereby establishing a laser scanning auxiliary coordinate system, wherein a direction vector of the incident laser beam in the laser scanning auxiliary coordinate system is:
$${A}_{in}^{′} = [ \begin{matrix}cos ( ω + Δω ) & 0 & sin ( ω + Δω ) \\ 0 & 1 & 0 \\ - sin ( ω + Δω ) & 0 & cos ( ω + Δω )\end{matrix} ] \cdot {A}_{in} ;$$
defining an angle between the reflector normal and the drive motor rotation shaft as η, accounting for the angular error Δη and the drive motor rotation angle error Δθ, wherein a direction vector of the reflector normal in the laser scanning auxiliary coordinate system is:
$$N = [ \begin{matrix}{N}_{x} \\ {N}_{y} \\ {N}_{z}\end{matrix} ] = [ \begin{matrix}sin ( η + Δη ) cos ( θ + Δθ ) \\ sin ( η + Δη ) sin ( θ + Δθ ) \\ - cos ( η + Δη )\end{matrix} ] ;$$
reversing the direction vector A′ᵢₙ and then rotating by 180° around N to obtain a direction vector of a reflected beam in the laser scanning auxiliary coordinate system as follows:
$${A}_{out}^{′} = [ \begin{matrix}2 {N}_{x}^{2} - 1 & 2 {N}_{x} {N}_{y} & 2 {N}_{x} {N}_{z} \\ 2 {N}_{x} {N}_{y} & 2 {N}_{y}^{2} - 1 & 2 {N}_{y} {N}_{z} \\ 2 {N}_{x} {N}_{z} & 2 {N}_{y} {N}_{z} & 2 {N}_{z}^{2} - 1\end{matrix} ] \cdot - {A}_{in}^{′} ;$$
rotating the direction vector A′ₒᵤₜ clockwise around a Y-axis of the laser scanning auxiliary coordinate system by ω+Δω to obtain a direction vector of the reflected beam in the laser scanning reference coordinate system as follows:
$${A}_{out} = [ \begin{matrix}cos ( ω + Δω ) & 0 & - sin ( ω + Δω ) \\ 0 & 1 & 0 \\ sin ( ω + Δω ) & 0 & cos ( ω + Δω )\end{matrix} ] \cdot {A}_{out}^{′} ;$$
defining a propagation speed of light in air as c, measuring a propagation time of a laser from the center of the airborne bathymetric LiDAR reflector to the laser footprint points through waveform detection as Δt, accounting for the laser ranging error ΔS, wherein a slope distance of laser propagation in air is calculated as:
$${S}^{′} = S + Δ S = 1 / 2 \times c \times Δ t + Δ S ;$$
thus, the coordinates of the laser footprints in the laser scanning reference coordinate system are:
$$[ \begin{matrix}{X}_{L} \\ {Y}_{L} \\ {Z}_{L}\end{matrix} ] = [ \begin{matrix}{f}_{x} ( S , θ , μ , Δ ω , Δ η , Δ S , Δ θ ) \\ {f}_{y} ( S , θ , μ , Δ ω , Δ η , Δ S , Δ θ ) \\ {f}_{z} ( S , θ , μ , Δ ω , Δ η , Δ S , Δ θ )\end{matrix} ] = {S}^{′} \cdot {A}_{out} .$$

7. The calibration method as claimed in claim 5, wherein the iteratively solving the error equation using a least-squares adjustment of indirect observation principle to derive structural error values of the conical scanning airborne bathymetric LiDAR system comprises:
expressing the error equation in a matrix form: V=BX−L;
where X=[δμ, δΔω, δΔη, δΔS, δΔθ, δα, δβ, δγ]^{T};
assuming a total number of the laser footprints as n laser footprints:
$$V = [ \begin{matrix}{V}_{1} \\ {V}_{2} \\ ⋮ \\ {V}_{i} \\ ⋮ \\ {V}_{n}\end{matrix} ] , B = [ \begin{matrix}{B}_{1} & 0 & … & 0 \\ 0 & {B}_{2} & … & 0 \\ ⋮ & ⋮ & {B}_{i} & ⋮ \\ 0 & 0 & … & {B}_{n}\end{matrix} ] , L = [ \begin{matrix}{L}_{1} \\ {L}_{2} \\ ⋮ \\ {L}_{i} \\ ⋮ \\ {L}_{n}\end{matrix} ] ;$$
where i represents an i-th laser footprint, and for each laser footprint:
$${V}_{i} = [ \begin{matrix}{v}_{ix} \\ {v}_{iy} \\ {v}_{iz}\end{matrix} ] ;$$
$${B}_{i} = [ \begin{matrix}\frac{\partial {F}_{x}}{\partial μ} & \frac{\partial {F}_{x}}{\partial Δω} & \frac{\partial {F}_{x}}{\partial Δη} & \frac{\partial {F}_{x}}{\partial Δ S} & \frac{\partial {F}_{x}}{\partial Δθ} & \frac{\partial {F}_{x}}{\partial α} & \frac{\partial {F}_{x}}{\partial β} & \frac{\partial {F}_{x}}{\partial γ} \\ \frac{\partial {F}_{y}}{\partial μ} & \frac{\partial {F}_{y}}{\partial Δω} & \frac{\partial {F}_{y}}{\partial Δη} & \frac{\partial {F}_{y}}{\partial Δ S} & \frac{\partial {F}_{y}}{\partial Δθ} & \frac{\partial {F}_{y}}{\partial α} & \frac{\partial {F}_{y}}{\partial β} & \frac{\partial {F}_{y}}{\partial γ} \\ \frac{\partial {F}_{z}}{\partial μ} & \frac{\partial {F}_{z}}{\partial Δω} & \frac{\partial {F}_{z}}{\partial Δη} & \frac{\partial {F}_{z}}{\partial Δ S} & \frac{\partial {F}_{z}}{\partial Δθ} & \frac{\partial {F}_{z}}{\partial α} & \frac{\partial {F}_{z}}{\partial β} & \frac{\partial {F}_{z}}{\partial γ}\end{matrix} ] ;$$
$${L}_{i} = [ \begin{matrix}{X}_{iG} - ( {X}_{iG} ) \\ {Y}_{iG} - ( {Y}_{iG} ) \\ {Z}_{iG} - ( {Z}_{iG} )\end{matrix} ] ;$$
formulating a normal equation based on the least-squares adjustment of indirect observation principle as:
$${B}^{T} BX = {B}^{T} L ;$$
solving the above normal equation as:
$$X = {( {B}^{T} B )}^{- 1} {B}^{T} L ;$$
substituting the coordinates of the laser footprints in the global control coordinate system (X_{G}, Y_{G}, Z_{G}), the slope distance S, the drive motor rotation angles θ, and approximate values of the undetermined parameters (μ, Δω, Δη, ΔS, Δθ, α, β, γ) into the above formula X=(B^{T}B)⁻¹B^{T}L to derive correction parameters of the undetermined parameters as ( [symbol] , [symbol] );
updating the undetermined parameters based on the correction parameters ( [symbol] , [symbol] ) as:
$$μ + \dot{μ} \to μ ;$$
$$Δω + \dot{Δω} \to Δω ;$$
$$Δη + \dot{Δη} \to Δη ;$$
$$Δ S + \dot{Δ S} \to Δ S ;$$
$$Δθ + \dot{Δθ} \to Δθ ;$$
$$α + \dot{α} \to α ;$$
$$β + \dot{β} \to β ;$$
$$γ + \dot{γ} \to γ ;$$
and
recalculating the coordinates of the laser footprints ((X_{G}), (Y_{G}), (Z_{G})) in the global control coordinate system using the undetermined parameters (μ, Δω, Δη, ΔS, Δθ, α, β, γ) after the updating, then recalculating a matrix B and a matrix L, and solving the normal equation of the error equation via the least-squares adjustment of indirect observation principle to obtain new correction parameters ( [symbol] ); repeating the above steps iteratively until absolute values of all correction parameters are less than 0.001.

8. An apparatus for calibrating structural errors in a conical scanning airborne bathymetric LiDAR system, comprising:
a first layout module, configured to deploy a plurality of global control points, a plurality of local control points, and a plurality of laser retroreflective targets on a target plane of a calibration field, and arrange two survey stations within the calibration field;
a second layout module, configured to deploy the conical scanning airborne bathymetric LiDAR system and a total station within a calibration field;
a first acquisition module, configured to acquire coordinates of the plurality of global control points in a global control coordinate system;
a second acquisition module, configured to acquire coordinates of the survey stations in the global control coordinate system;
a third acquisition module, configured to acquire coordinates of the plurality of local control points and a center of an airborne bathymetric LiDAR reflector in the global control coordinate system;
a fourth acquisition module, configured to acquire slope distances from the center of the airborne bathymetric LiDAR reflector to laser footprints on the plurality of retroreflective targets and drive motor rotation angles;
a fifth acquisition module, configured to acquire coordinates of the laser footprints in the global control coordinate system;
a construction module, configured to construct an error equation; and
a computation module, configured to solve the error equation to derive structural error values of the conical scanning airborne bathymetric LiDAR system.
